(19) United States
(12) Patent Application Publication
(10) Pub. No.: US 2002/0152467 A1
(43) Pub. Date: Oct. 17, 2002

(54) Automated generation of conditional access packets for IRD upgrades via radio frequency software download in satellite television systems

(76) Inventor: Rosario Fiallos, Miami, FL (US)

Correspondence Address: HUGHES ELECTRONICS CORPORATION, PATENT DOCKET ADMINISTRATION, BLDG 001 M/S A109, P O BOX 956, EL SEGUNDO, CA, 902450956

(21) Appl. No.: 09/948,976

(22) Filed: Sep. 7, 2001

Related U.S. Application Data
(60) Provisional application No. 60/268,480, filed on Feb. 12, 2001.

(51) Int. Cl. G06F 15/16; H04N 7/20; G06F 3/00; H04N 5/445; G06F 13/00

(52) U.S. Cl. 725/50; 725/67; 725/63; 709/231

(57) ABSTRACT

An automated system and method for pre-processing software update parameters for transmission to IRDs via traditional broadcasts without the necessity for repeated manual intervention. Generally, the present invention is a system that automatically generates software download commands containing all the necessary parameters that an IRD in a satellite-communication network requires to complete a software download, such as time, frequency, the location of the software within the data stream, among other parameters. The invention provides software upgrade data to be transmitted in data packets that comprise a satellite broadcast. The transmitted information includes target broadcast receiver (IRD) identification information and software upgrade information to determine if the targeted IRD is indeed the correct recipient of the software upgrade data, and if the IRD requires a software upgrade. The urgency of the upgrade is determined to allow upgrades to be mandatory, optional, deferred to a later time period, or cancelled. The upgrade information is broadcast via typical satellite transmissions and occurs periodically without any human intervention, depending on the current upgrade version of the IRD.

### BACKGROUND OF THE INVENTION

1. Field of the Invention

The invention generally relates to a method and system for updating the software of user IRDs in satellite-based broadcast systems and more specifically to an automated method and system for pre-processing software update parameters for transmission to IRDs via traditional broadcasts without the necessity for repeated manual intervention.

2. Description of the Prior Art

Satellite-based interactive television systems are increasing in popularity throughout the world, as TV viewers are now able to use new services such as teleshopping, ticket ordering, near video on demand and interactive game shows. Additional applications for interactive TV range from marketing to education. It may also serve to bridge the gap between cable and Internet types of services.

The basic components of a satellite-based interactive television system are one or more transmitting earth stations, the uplink system, one or more communication satellites, the downlink system, and one or more receiving earth stations. Satellites contain transceivers that receive and transmit signals, including video programming, telephone calls and data. Other key components of the system are the Application Server, for developing applications and delivery of information through the network to the user's home; the interactive Integrated Receiver/Decoders (IRD), which runs the Open TV operating system and decodes the video and audio streams; the Transaction Server, which receives responses from the home and forwards them to the service provider's Fulfillment Server, which processes the orders for the customer.

Frequently, the user's IRD must be updated to allow the user to continue to utilize the interactive capabilities of the system. The IRD manufacturer must supply the satellite broadcast center with the IRD parameters necessary to complete an IRD upgrade. The update parameters can then be programmed and broadcast via traditional RF broadcasts. One disadvantage associated with updating IRDs in conventional satellite broadcast systems is that each update must be done manually and requires the user to enter update information (time, frequency and IRD identification information) manually while utilizing three different software platforms; DOS, Windows and UNIX, before completing the update. This lengthy process wastes time, money and manpower.

Accordingly, what is needed in the art is an automated IRD software update system and method which can automatically generate software download commands for transmittal to the user via traditional satellite-based broadcasts, and that allows the IRDs to be automatically updated without repeated human intervention while doing away with the necessity of entering the update information via three separate software platforms.

It is, therefore, to the effective resolution of the aforementioned problems and shortcomings of the prior art that the present invention is directed.

### SUMMARY OF THE INVENTION

Generally, the present invention is a system that automatically generates software download commands containing all the necessary parameters that an IRD in a satellite-communication network requires to complete a software download, such as time, frequency, the location of the software within the data stream, among other parameters.

The present invention creates a script that will read from files without the necessity of human intervention and does away with the necessity of using three platforms (DOS, Windows, Unix) by using input files and Unix processing with automatic call up.

Specifically, the invention is a method for automatically generating a software download command for upgrading IRDs in a satellite-based communication network comprising the steps of obtaining an IRD upgrade code and IRD information which is private to an IRD's manufacturer, generating a file containing the private IRD manufacturer information and formatted IRD upgrade code, transmitting the formatted IRD upgrade code to a broadcast center, entering IRD upgrade parameters, selecting a target IRD or target geographical location containing IRDs which are to receive the upgrade code, generating a software download command using a single software platform, the software download command including formatted target IRD information, creating a batch file including the software download command and the formatted IRD upgrade code, and broadcasting contents of the batch file in a traditional satellite uplink broadcast.

Therefore, it is an object of the present invention to provide an automated method and system for pre-processing software update parameters for transmission to identified IRDs via traditional broadcasts without the necessity for repeated Ad manual intervention.

It is to be understood that both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

In accordance with these and other objects which will become apparent hereinafter, the instant invention will now be described with particular reference to the accompanying drawings.

### BRIEF DESCRIPTION OF THE DRAWINGS

FIG. 1 illustrates a typical satellite-based communication system utilizing the present invention.

FIG. 2 illustrates, in block diagram form, the overall information flow utilizing the preferred embodiment of the present invention.

FIG. 3 represents, in block diagram form, the specific steps undertaken by the preferred embodiment of the present invention to automatically generate software download commands.

FIG. 4 represents a data packet illustrating the command structure of an Upgrade Announcement utilizing the present invention.

FIG. 5 represents a data packet illustrating the command structure of a Public Announcement utilizing the present invention.

FIG. 6 represents a data packet illustrating the command structure of the Upload File as presented to the Broadcast Station utilizing the present invention.

FIG. 7 represents a data packet illustrating the command structure of the Header portion of the Upload File of the present invention.

FIG. 8 represents a data packet illustrating the command structure of the Private Announcement portion of the Upload File of the present invention.

FIG. 9 represents a data packet illustrating the command structure of the Data Block portion of the Upload File of the present invention.

FIG. 10 represents a flowchart illustrating the steps taken by the present invention in determining if an IRD is to receive software upgrade information.

### DESCRIPTION OF THE PREFERRED EMBODIMENTS

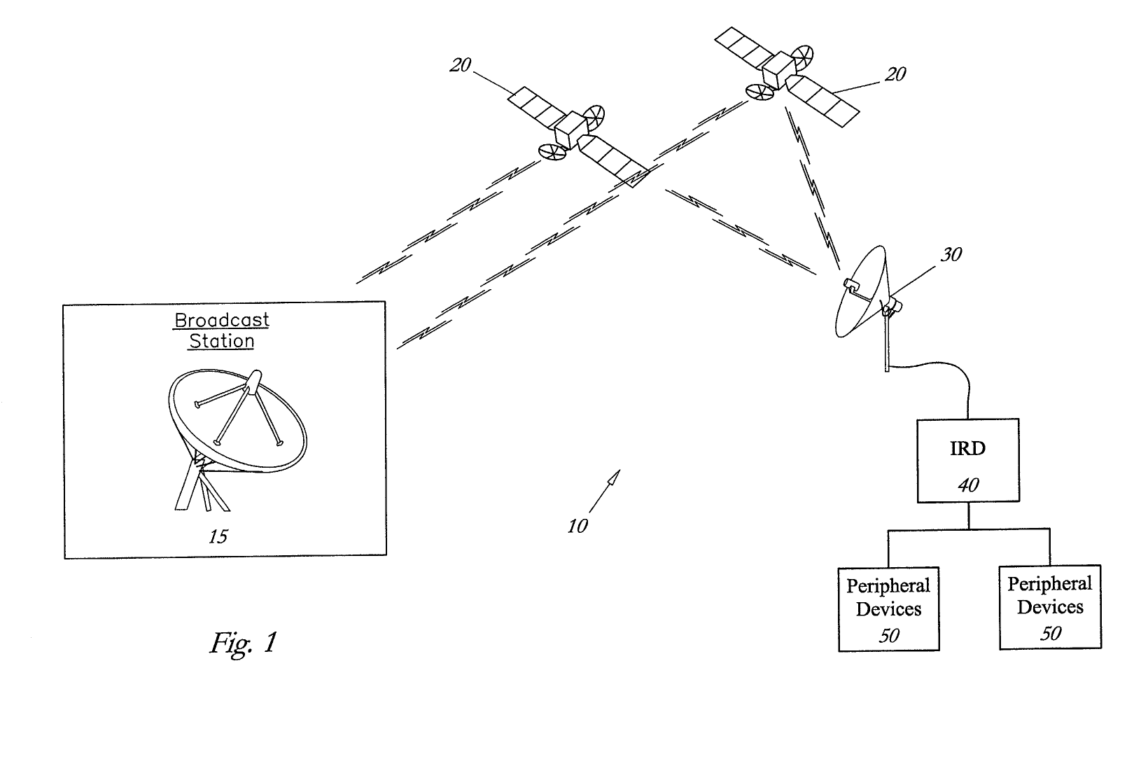

Referring to FIG. 1, the system architecture of the present invention 10 is shown. The invention is a method and system for upgrading IRD software in a streamlined, nonintrusive and efficient manner.

FIG. 1 illustrates the uplink and downlink portions of a typical satellite communication network. A Broadcast Center 15 receives IRD parameters from the IRD manufacturer. This information is included in broadcast transmission to a plurality of communication satellites 20, which then transmit the broadcast signals to a user-receiving antenna 30. Antenna 30 is electrically coupled to a broadcast receiver (IRD) 40, which is electrically coupled to one or more peripheral devices 50 such as a television, personal computer, PDA or other digital or analog receiving device.

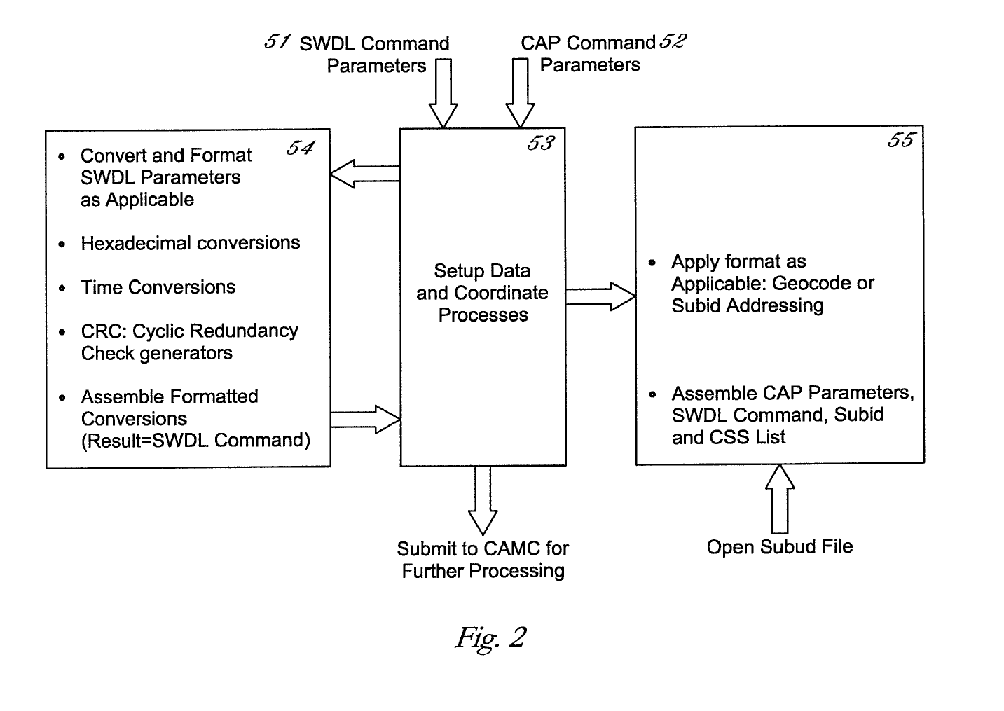

FIG. 2 illustrates, in block diagram form, the process taken by a computer operator using the present invention to automatically generate software download commands having all the necessary parameters that an IRD in a satellite-communication network requires to complete a software download. The process involves the creation of a Unix shell script to enable the bypassing of the time-consuming repeated task of using multiple platform programs and having to interface each.

A computer operator receives the IRD upgrade code 51 from the IRD manufacturer as well as CAP Command parameters 52. The operator then runs a DOS program (dtv2mpt) to generate a template with manufacturer private data (properties of the code to be downloaded) and a Multi Packet Transport (MPT) file (MPT packet formatted code to be downloaded).

The MPT file is then broadcast into a traditional satellite broadcast in a previously determined Service Identification number (SCID) and transponder. The SCID and transponder are part of the SWDL parameters 51. A Unix script, called CAPannounce is then run to generate a CAP file. The CAP file contains private information, the upgrade code and public information, supplied by the broadcaster, including the target IRDs which are to receive the upgrade.

Once the code and command parameters have been received and processed, step 53, the software code is formatted, target IRDs are identified and hexadecimal and time conversions take place, step 54. The broadcaster decides if specific IRDs are to receive the upgrade, and if so, enters the appropriate identification numbers. Alternatively, a geocode is identified as corresponding to a certain geographic region, wherein all IRDs within the region are to receive upgrades, step 55. The result is a batch file that is output to a broadcast center where it is uplinked in a traditional satellite broadcast.

Once the upgrade code 51 and CAP command parameters 52 have been received by the computer operator, and the data has been formatted and entered, the remaining steps can be completely automated, i.e. the steps of identifying target IRDs or geographic areas, frequency of updates, time of each update, etc. can be programmed once and need not be programmed again. The CAPannounce script allows software upgrades to automatically occur without the need for constant re-programming and re-entering of date.

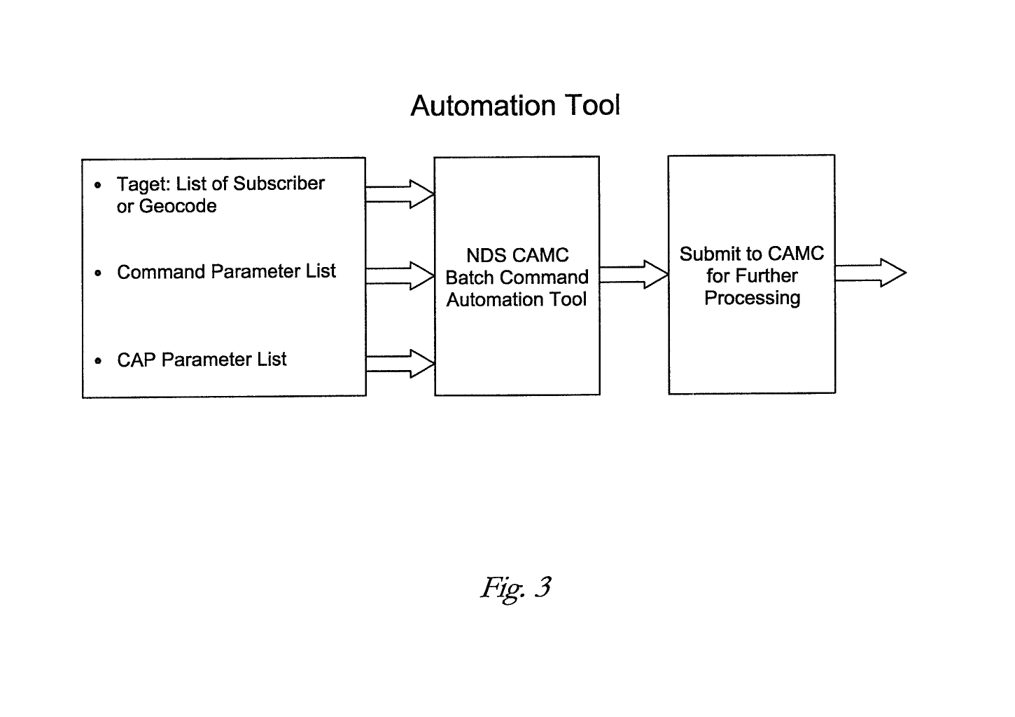

FIG. 3 is a block diagram illustrating the flow of information from the operator who enters command parameters and target list to the generation of a batch file through the submission of the file to a Conditional Access Management Center (CAMC) for uplinking. Variations of the present invention may be used for automation of other batch generation such as Customer Service Center (CSS) initiated callback, modem parameter download, and IRD e-mail.

An Upgrade Announcement is used to notify the user's IRD 40 when upgrade opportunities are available. The announcement appears as a “Data Sent” message to IRD 40 via a Conditional Access Packets (“CAP”) stream command. The entire software upgrade process operates as a series of sessions. The announcement is used to describe a session in greater detail.

A unique session ID number is defined for every software upgrade version. The same software version broadcast at different times may have the same Session ID. Further, the same software version broadcast at different times may have the same Session Version. For example, two sessions with the same software upgrade may have the same Session ID and Session Version, but different start times. This is to allow for network flexibility.

The software upgrade may be broadcast in a continuous, low data rate, within the constraints of the duration field, or at a high data rate intermittently. In either scenario, IRD 40 processes the software upgrade. The upgrade starts at the announced broadcast start time(s) and repeats back-to-back as for the announced session duration. The range of operation may be as few as two sessions per day with two broadcasts of the same software upgrade per session, up to a continuous broadcast.

The number of broadcasts of the software upgrade is equal to the duration divided by the time required to broadcast the software upgrade one time. The time required to broadcast the software upgrade one time is equal to the software upgrade image size (plus overhead) divided by the data rate of the broadcast. For example, a 1 Mega-byte image broadcast at a 1 Mega-bit per second data rate for duration of 16 seconds would be broadcast twice.

All IRDs must be able to support a minimum data rate of 100 kbps. At this data rate, all IRDs receive and process the software upgrade file in a time consistent with 80 seconds per 1 MB of code plus no more than an additional 5 minutes until the software upgrade process is complete and video and audio is displayed. For higher data rates this duration is scaled according to the data rate.

Announcements are repeated continuously prior to and during the course of an upgrade. The lead-time to the upgrade may vary from immediately before, to any time prior, depending on the characteristics of the upgrade schedule and the operational agreements. The repeat cycle for the announcements can run from several times a minute to once a day. Nominally, the cycle time will be once per 30 minutes possibly increasing in frequency a short time prior to the software upgrade broadcast. However, the IRD should be capable of accommodating any frequency of announcements.

After the last software upgrade session, a command with the urgency field set to zero is sent to cancel any pending software upgrade attempts. IRD 40 cancels a pre-announced, but yet-to-be broadcast software upgrade when an announcement with an urgency field set to zero is received.

During nominal operation each software upgrade is assigned a unique SCID. IRD 40 preferably accepts and processes no more than one software upgrade at a time. The session version field enables network parameters to be changed at anytime prior to a software upgrade without invoking user interface interaction. When a Session Version value is incremented, IRD 40 shall check for variation in the public announcement fields such as Network ID, Transponder, SCID, Start Time, and Duration, and update to the most recent value. The IRD manufacturer may decide to replace all public announcement fields.

IRD 40 receives the entire software upgrade and performs a signature verification, prior to replacing the current code. The IRD performs digital signature verification on the received image. Given theoretically perfect link conditions, IRD 40 is capable of receiving the software upgrade in one broadcast session. If IRD 40 does not successfully receive or does not successfully validate the software download, the IRD does not corrupt the operational code and shall resume normal operation.

If IRD 40 is in the ON state at the start of the software upgrade reception, the IRD displays on-screen text stating the current temporary inoperable status of the IRD during the software upgrade session or until the IRD has received the complete code. If IRD 40 is in the ON state at the start of the software upgrade reception, the IRD shall display a status bar, or indicate a percent complete status during the software upgrade.

CAP and program guide reception and processing are required continuously before the software upgrade begins and are generally preferred during the reception of the first byte of the software upgrade code through the verification of the received code, but before the write to non-volatile (“FLASH”) memory. CAP and program guide reception and processing are not required during the process of writing to FLASH memory.

An “Upgrade” option button is available in the main menu for information related to the software upgrade. When selected, the “Upgrade” button shall present the “Future Upgrades” and “Past Upgrades” information option buttons.

A button labeled “Future Upgrades” provides information to the user from the menu system. The date, time and code version of the upgrade shall be displayed.

A button labeled “Past Upgrades” provides current code version and date and time received to the user from the menu system.

If the configuration of the ODU (Out Door Unit) does not support a software upgrade, the IRD shall reject the announcement.

Information is made available to the user indicating that once an upgrade is completed, the old code version may not be restored. If IRD 40 does not receive the signal during the software upgrade broadcast time (because of rain fade, for example), the IRD shall recognize, upon reacquisition, that it did not receive the scheduled software upgrade. IRD 40 then displays on-screen text indicating the unsuccessful attempt and that it will try again at the next opportunity. The On-Screen Display (OSD) shall timeout after a period of 60 seconds and not reappear until another unsuccessful upgrade attempt is made.

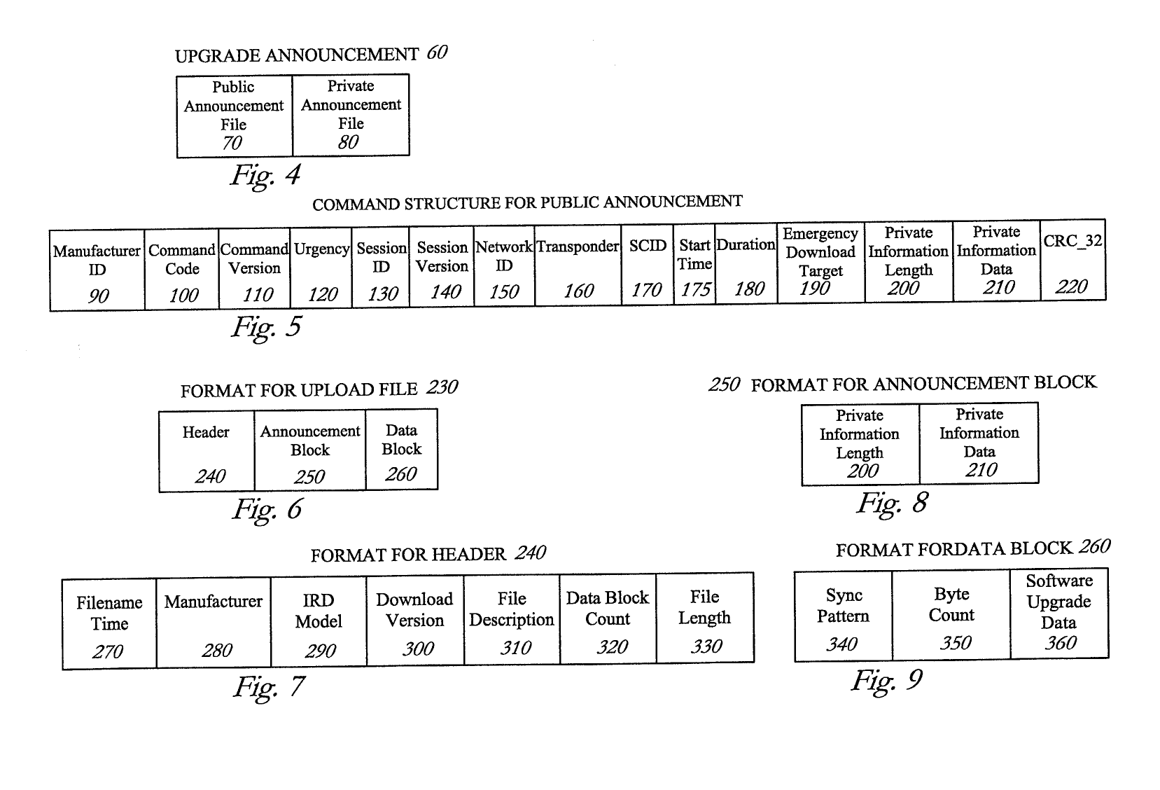

Referring to FIG. 4, the Upgrade Announcement file 60 is comprised of public command fields 70 and private command fields 80 held private by the IRD manufacturers. The public command fields 70 apply to all IRD manufacturers. The private command fields 80 are unique to each IRD manufacturer.

The IRD manufacturer supplies a field in the private data announcement specifying the number of software upgrade attempts before failure is declared. An attempt shall be defined as when a signature verification has started on the received download code prior to replacing the current code. It is assumed that the IRD will have received the number of data blocks equal to the data block count and ordered them correctly. The IRD deems the software upgrade to be a failure if the verification was correct, but the software upgrade failed to properly replace the current code. When the number of unsuccessful attempted software upgrades attempted is reached, the IRD shall display on-screen text stating the lack of success and instruct the user to take appropriate action. If the IRD has the capability to display video and audio, then after user acknowledgement the OSD shall disappear and the IRD shall display video and audio.

The goal of the announcement format is to allow IRD 40 to quickly identify whether an announcement is required and to allow each manufacturer to define private fields specific to their products for further filtering. IRD 40 schedules a specific session for reception. The announcement structure shall announce one session at a time. Multiple announcements can be active at any time. IRD 40 stores the next available announcement in non-volatile memory. IRD 40 then schedules the next available start time. If the IRD is capable of storing multiple announcements, they are stored chronologically with the next available start time being first to be acted upon by the IRD. Announcements with expired start times are discarded.

What follows below is a brief description of each of the public command fields 70, transmitted as part of Upgrade Announcement 60. Although each field is described as a specific size, it is within the spirit of the invention to provide larger size data fields if necessary for the successful transfer of upgrade information.

FIG. 5 shows the command data format for public announcement field 70. The Manufacturer ID field 90 is typically a ½-byte field identifying the IRD manufacturer for the present software upgrade. The Manufacturer ID must exactly match the Manufacturer ID stored in the IRD for the upgrade session to be scheduled. In this light, other parameters must be met (see FIG. 8).

The Command Code 100 is typically a 1 ½-byte field defining the command code. In the present embodiment, for example, software upgrades use the command code having a value of 11.

The Command Version block 110 is typically a 1-byte field specifying the version of the command code. This initial version is 0. The IRD will take no action and ignore other versions.

The Urgency block 120 is typically a 1-byte field indicating how intrusive the IRD should be in performing the upgrade. The IRD only responds to certain values. For example, values of 0, 2, 100, 101, and 255 provide information to the IRD regarding the level of urgency regarding the present upgrade. The announcement is ignored if the Urgency values are other than 0, 2, 100, 101, or 255 (in this example).

The Session ID block 130 is typically a 3-byte field identifying the software upgrade session. Each session is assigned a unique Session ID number.

The Session Version 140 is typically a 1-byte field identifying the version of the software upgrade session. Session Version 140 enables modification to the network parameters without invoking user interaction. Any change in the command fields starting from Network ID through CRC₁₃32 (explained below) is processed by IRD 40 to further determine if any user interface interaction is required.

The Network ID 150 block is a 1-byte field which identifies which network the software upgrade will occur over. For example, a Satellite Network (A) may consist of satellite services broadcast from the 95-degree West orbital location. Network ID values are typically defined from 0 to 255. So, for example, if the value of the Network ID block is “0”, then Network A is defined. Other Network IDs can be reserved for future use.

The Transponder block 160 is typically a 1-byte field indicating which transponder the data is on. For example, a value of 1 may refer to transponder 1. This field uses a ones-based numbering scheme.

The SCID value 170 is a 12-bit field that identifies the packet SCID carrying this software upgrade. Typically, the upper 4 bits are unused and are listed as zero. Each software upgrade, uniquely identified by Session ID 130, shall be delivered on a unique SCID.

The Start Time field 175 typically refers to a 4-byte field which identifies the start time of the software upgrade session. This is generally defined as the number of GPS seconds since 12 AM Jan. 6, 1980.

The Duration field 180 is, typically, a 3-byte field defining the duration of the software upgrade session, measured in seconds. The duration shall be an integer multiple of software upgrade images broadcast during the session.

The Emergency Download Target value 190 represents a 4-byte field that enables the manufacturer's IRD 40 to allow reception of a decremented version of code. An Emergency Download Target value 190 of 0×00000000, hexadecimal, indicates that the manufacturer's IRD shall use its default upgrade method, meaning that it allows only incremented versions of code to be introduced to the IRD. A non-zero hexadecimal Emergency Download Target value 190 specifies the code version for which this upgrade is targeted. If the Emergency Download Target value 190 specified does not match the current software model and version of the IRD, Upgrade Announcement 60 shall be rejected. If Emergency Download Target value 190 does match the current software model and Session Version 140, Announcement 60 shall be processed.

The Private Information Length block 200 is typically a 1-byte field containing information indicating the number of bytes of the Private Information Data field 210.

Private Information Data field 210 refers to a variable length structure specifying software upgrade parameters private to the manufacturer identified by Manufacturer ID. Fields 200 and 210 contain information which is supplied by the IRD manufacturer and forwarded to the satellite broadcast center. It is at the broadcast center where Announcement 60 is created and which includes this information.

The CRC₁₃32 block 220 is a 4-byte error check field. This is the industry standard MPEG CRC-32 applied to the entire announcement.

MPT Flag

| Frame | Error Detection | | |
|---|---|---|---|
| Type | Type | SOF | EOF |
| 4 bits | 2 bits | 1 bit | 1 bit |

Each software upgrade is delivered using an MPT data packet format. The MPT frame consists of assembling 1 or more MPT packets together.

MPT Flag Frame Type Definition

| Frame | |
|---|---|
| Type | Meaning |
| 0 | Ethernet Frames |
| 1 | Vendor Streams |
| 2 | General Purpose |
| | Download |
| 3 | Advanced |
| | Program Guide |
| 4 . . . 15 | Reserved |

The above table refers to the MPT Flag Frame Type definitions. The Frame Type is a 4-bit field identifying this version of the MPT packet. For example, the version ranges may be from 0 to 15. A Frame Type value of 2 is generally used for all software upgrades.

The Error Detection Type field, illustrated in the table below is typically a 2-bit field identifying the Cyclic Redundancy Check (CRC) or Checksum method being employed. Error Detection Type value of 0=CRC-32 with MPT flags field included in the CRC calculation, are generally used by all manufacturers.

MPT Framing Error Detection Type

| Error Detection | |
|---|---|
| Type | Meaning |
| 0 | CRC-32 with MPT flags field included |
| | in the CRC calculation. |
| 1 | None |
| 2 | CRC-32 without MPT flags field |
| | included in the CRC calculation |
| 3 | 32-bit checksum without MPT flags |
| | field included in the checksum |
| | calculation. Required for MPT |
| | Version equal to 3. |

Type of MPT Packets
Start Packet

| Frame | Error | | | | |
|---|---|---|---|---|---|
| Type = | Detection | SOF = | EOF = | Session | |
| 0 × 2 | Type | 1 | 0 | ID | Data |
| 4 | 2 bits | 1 bit | 1 bit | 3 bytes | 123 bytes |
| bits | | | | | |

Middle Packet(s) if any

| Frame | Error | | | |
|---|---|---|---|---|
| Type = | Detection | SOF = | EOF = | |
| 0 × 2 | Type | 0 | 0 | Data |
| 4 | 2 bits | 1 bit | 1 bit | 126 bytes |
| bits | | | | |

End Packet

| | | | | | CRC-32 |
|---|---|---|---|---|---|
| Frame | Error | | | | or Check- |
| Type = | Detection | SOF = | EOF = | | sum or |
| 0 × 2 | Type | 0 | 1 | Data | None |
| 4 | 2 bits | 1 bit | 1 bit | 126 or 122 bytes | 0 or 4 |
| bits | | | | | bytes |

Start and End Packet

| | | | | | | CRC_{—} |
|---|---|---|---|---|---|---|
| Frame | Error | | | | | 32 or |
| Type = | Detection | SOF = | EOF = | Session | | Checksum |
| 0 × 2 | Type | 1 | 1 | ID | Data | or None |
| 4 | 2 bits | 1 bit | 1 bit | 3 Bytes | 123 or 119 | 0 or 4 |
| bits | | | | | bytes | bytes |

There are four different types of MPT packets. These are determined by four possible combinations resulting from SOF and EOF flags being set to either 0 or 1.

The SOF field is a 1-bit field. When set to “1”, it indicates that the start of an MPT Frame occurs in this MPT packet. When this field is set to “0” the MPT packet does not contain the MPT Frame Header.

The EOF field is typically a 1-bit field; when set to “1”, it indicates that the end of an MPT Frame occurs in this MPT packet. When set to “0”, the MPT packet does not contain the MPT Frame Trailer.

MPT packets are transmitted in the order in which they should be reassembled. It is generally not permissible to transmit the packets out of order.

MPT packets are multiplexed within an MPT Frame. That is, once an SOF bit is set, all subsequent MPT packets on the SCID shall belong to the same MPT Frame, in order.

The Error Detection mechanisms are per frame, so either an entire frame shall be received intact or the complete frame shall be discarded. For example, if packets are dropped due to transport, rain fade, or whatever reason, then the entire frame must be dropped.

The Broadcast Station 15 receives a Software Upgrade delivery Package (“Upload File”) 230 from the IRD manufacturer. It is delivered to the Station 15 as one file. The file consists of a header record followed by the announcement block and one or more data blocks. Each data block shall be guaranteed to start at the beginning of a MPT Frame. The entire file shall be broadcast one or more times during a download session.

The Upload File format consists of three sections: 1) Header 240, 2) Private Announcement Block 250, and 3) Data Blocks 260, shown in FIG. 6. The purpose of Header 240 is to allow Station 15 to be able to read and understand what a particular file is for. This is primarily used for file management and maintenance purposes. Each of the records shall be delimited with a line feed character.

The format of Header 240 is depicted in FIG. 7. The format of the Header data structure comprises a Filename 270 which represents a variable length field identifying the name of the upload file.

The Manufacturer block 280 represents a variable length field identifying the IRD manufacturer for the software upgrade contained in this upload file.

Other fields are the IRD Model field 290, a variable length field describing the IRD model for the software upgrade in this upload file, a Download Version field 300 describing the version of the software upgrade contained in the upload file, the File Description field 310, which is a variable length field of description text for the software upgrade contained in this upload file, a Data Block Count field 320 which contains up to 10 characters indicating the number of data blocks contained in this upload file, and the File Length field 330, representing up to 10 characters indicating the number of bytes for all fields in the update file following the File Length field.

FIG. 8 illustrates the format of Private Announcement Block 250. The Private Information Length field 200, described earlier as part of the public command fields 70 is a 1-byte field indicating the number of bytes in the Private Information Data field 210.

The Private Information Data portion is a variable length structure of preferably no more than 62 bytes, specifying software upgrade parameters private to the manufacturer identified by Manufacturer ID.

FIG. 9, shows the format structure of Data Block 260, which includes a Sync Pattern field 340 that shall be set to Ox55aacc55 to signify the beginning of a Data Block, to facilitate data packetization at the uplink. The Byte Count block 350 is a 4-byte field indicating the number of bytes of the Software Upgrade Data. The Software Upgrade Data field 360 is a variable structure which contains the actual software upgrade data as defined by the IRD manufacturer.

Each data block 260 shall be used to signal points in the download that must be aligned to an MPT Frame. At least one data block is required. The IRD manufacturer may place as many as required in the data file to meet their packetization requirements.

The Data portion 360 in each data block 260 shall start aligned in an MPT Frame immediately following Session ID field 130. Sync Pattern 340 and Byte Count 350 are not broadcast, but merely sent to Broadcast Station 15. The SOF flag shall be set and the EOF flag cleared. All subsequent MPT packets in the Frame except the last shall have both the SOF and EOF flags clear. The last packet shall be nullified if the remaining data in the data block does not fill the whole packet and the EOF flag shall be set.

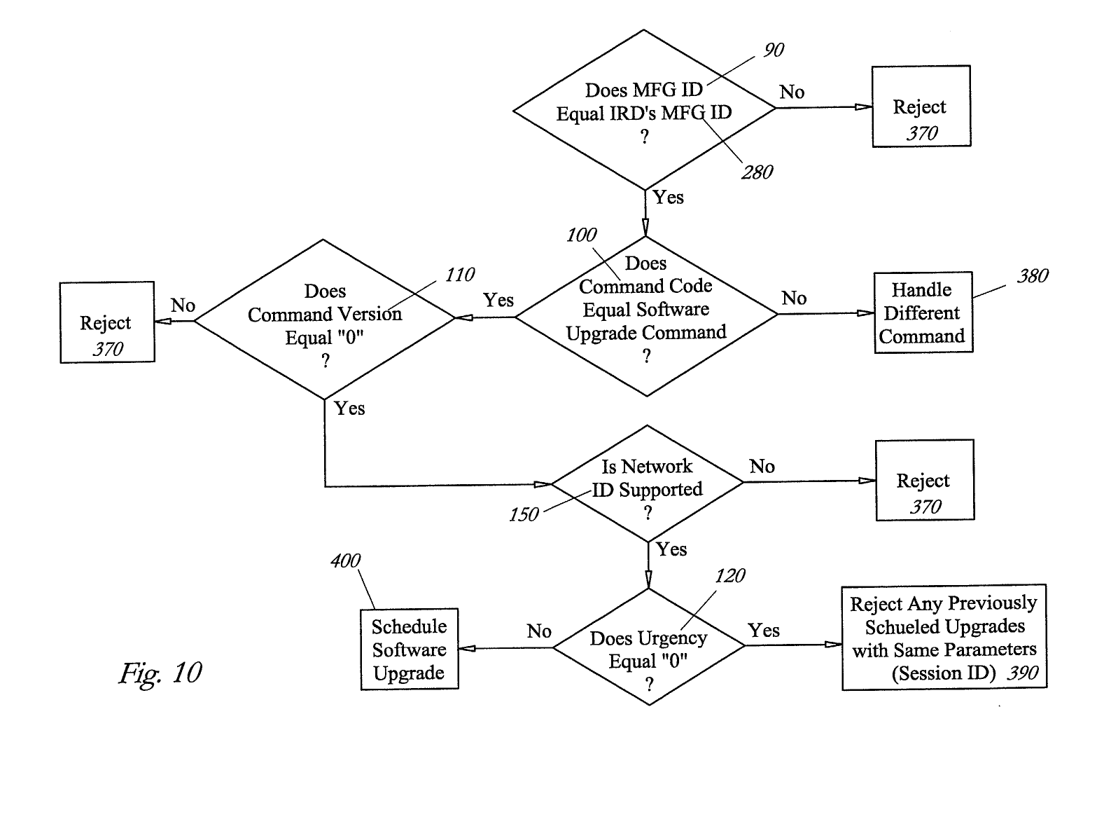

FIG. 10 illustrates the conditions in which the IRD shall accept a software upgrade command and schedule an upgrade. If the IRD rejects the software upgrade command, then no further processing for the upgrade shall be done. If the IRD accepts the software upgrade command, then an upgrade event shall be scheduled at the indicated time. The steps of FIG. 8 are reproduced below:

IF (Manufacturer ID 90 not equal IRD's Manufacturer ID 280) Reject 370

IF (Command Code 100 not equal to software upgrade command) Handle different command 380

IF (Command Version 110 not equal to 0 or what IRD 40 can handle) Reject 370

IF (Network ID 150 not supported) Reject 370

IF (Urgency 120 equal to 0) Reject any previously scheduled upgrades with the same parameters 390 (Session ID)

ELSE Schedule Software Upgrade 400

Upgrade scheduling is based on the Urgency field 120. The first implementation of the software upgrade capability shall only incorporate the certain Urgency values such as, for example, 0, 2, 100, 101, and 255. The announcement shall be ignored if the Urgency value is other than 0, 2, 100, 101, or 255. The IRD manufacturer shall allow flexibility to incorporate gradations of urgency in future upgrades. The IRD shall not exhibit anomalous performance if the Urgency field is incorrectly defined as other than 0, 2, 100, 101, and 255.

The following are examples of Urgency values and their corresponding instructions:

0 The IRD is never upgraded for Session ID 130 identified in announcement 60 (used to cancel previous software upgrade commands).

2 Optional upgrade: If the IRD is in standby, the software upgrade is performed. The IRD is not turned on to display the OSD. Otherwise, if the IRD is on, display on-screen text allowing the user to delay the software upgrade. Display OSD 2 minutes prior to reception of software upgrade. Delay upgrade if Pay-Per-View (PPV) is showing or a scheduled timer is active, or if a conflict between the upgrade and a PPV or a scheduled timer is determined or if an interactive application does not relinquish control of the IRD within the session duration time.

100 Auto-Upgrade (Optional): If a valid announcement is determined and Urgency field 120 is set to a value of 100, the IRD shall not consider the start time and shall display OSD for 2 minutes prior to reception of software upgrade if the IRD is on. If the IRD is in standby, perform the software upgrade immediately. Do not turn on the IRD to display the OSD. If the IRD is on, display on screen text allowing the user to delay the software upgrade. Delay upgrade if PPV is showing or a scheduled timer is active or if a conflict between the upgrade and a PPV or a schedule timer is determined or if an interactive application does not relinquish control of the IRD within the session duration time.

101 Auto-Upgrade (Mandatory): If a valid announcement is determined and Urgency field 120 is set to a value of 101, the IRD shall not consider the start time and shall display OSD for 2 minutes prior to reception of software upgrade if the IRD is on. If the IRD is in standby, perform the software upgrade. Do not turn on the IRD to display the OSD. The user shall not be given the option to delay the pending software upgrade. The software upgrade shall occur even if PPV is showing or a scheduled timer is active or if a conflict between the upgrade and a PPV or a scheduled timer is determined. In the case where an interactive application is in control of the IRD and it does not relinquish control of the IRD within the session duration time, a single attempt to perform the software upgrade shall be made by the IRD upon interactive application exit.

255 Mandatory upgrade: If the IRD is in standby, perform the software upgrade. Do not turn on the IRD to display the OSD. The user shall be notified prior to start of the upgrade if the IRD is on. The user shall not be given the option to delay the pending software upgrade when the Urgency field is set to 255. The software upgrade shall occur even if PPV is showing or a scheduled timer is active. Display OSD 2 minutes prior to reception of software upgrade. The IRD shall begin to receive upgrade image at the announced Start Time.

Once scheduled, IRD 40 attempts to upgrade at each opportunity until the download is successful, the number of attempts failed threshold is reached, or until the session duration is complete. In the case where an interactive application is in control of the IRD and it does not relinquish control of the IRD within the session duration time, a single attempt to perform the software upgrade shall be made by the IRD upon interactive application exit.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for automatically generating a software download command for upgrading IRDs in a satellite-based communication network comprising the steps of:
obtaining IRD upgrade code and IRD information private to an IRD's manufacturer;
generating a file containing the private IRD manufacturer information and formatted IRD upgrade code;
transmitting the formatted IRD upgrade code to a broadcast center;
entering IRD upgrade parameters;
selecting a target IRD or target geographical location containing IRDs which are to receive the upgrade code;
generating a software download command using a single software platform, said software download command including formatted target IRD information;
creating a batch file including said software download command and said formatted IRD upgrade code; and
broadcasting contents of said batch file in a traditional satellite uplink broadcast.

2. A method for providing software upgrade data to a receiver in a satellite broadcast system comprising the steps of:
notifying a broadcast receiver when a software upgrade is available;
determining the urgency of said software upgrade for said broadcast receiver;
scheduling a software upgrade session for the broadcast receiver, said software session comprising one or more software upgrade data transmissions; and
periodically transmitting data packets containing software upgrade data for said scheduled software upgrade session, to said broadcast receiver.

3. The method of claim 2 wherein said step of notifying the broadcast receiver when said software upgrade is available is comprised of the step of providing an upgrade announcement message, transmitted in said data packets.

4. The method of claim 3 wherein the step of scheduling said software upgrade session comprises the steps of:
storing one or more private identification parameters within a memory storage device located in each said broadcast receiver, said private identification parameters provided by the IRD's manufacturer;
transmitting, within said data packets, public identification parameters, said public identification parameters provided by a satellite television broadcast provider; and
determining if said transmitted public identification parameters are equal to said stored private identification parameters, and if not equal, canceling said software upgrade session.

5. The method of claim 2 further comprising the steps of determining if said software upgrade session is comprised of more than one said transmission, and if so, sequentially storing, in a memory storage medium, subsequently transmitted software upgrade data corresponding to the scheduled software upgrade session.

6. A system for providing software upgrade data to a receiver in a satellite broadcast system comprising:
one or more peripheral devices; and
a broadcast receiver electrically connected to said one or more peripheral devices for notifying a broadcast receiver when a software upgrade is available, said broadcast receiver capable of receiving notification of transmitted data packets containing a broadcast receiver software upgrade, wherein said transmitted data packets comprises means for determining the urgency of said software upgrade for said broadcast receiver, means for scheduling a software upgrade session for the broadcast receiver, said software session comprising one or more software upgrade data transmissions and means for periodically transmitting data packets containing software upgrade data for said scheduled software upgrade session, to said broadcast receiver.

7. The system of claim 6 wherein the broadcast receiver is notified of said software upgrade by receiving an upgrade announcement message, transmitted via said data packets.

8. The system of claim 6 wherein said means for scheduling said software upgrade session comprises:
means for storing one or more private identification parameters within a memory storage device located in each said broadcast receiver, said private identification parameters provided by the IRD's manufacturer;
means for transmitting, within said data packets, public identification parameters, said public identification parameters provided by a satellite television broadcast provider; and
means for determining if said transmitted public identification parameters are equal to said stored private identification parameters, and if not equal, canceling said software upgrade session.

9. The system of claim 8 further comprising means for determining if said software upgrade session is comprised of more than one said transmission, and if so, providing means for sequentially storing, in a memory storage medium, subsequently transmitted software upgrade data corresponding to the scheduled software upgrade session.

10. The system of claim 6 wherein said memory storage medium is non-volatile memory.

11. A computer program stored in a computer readable medium, embodying instructions to perform a method for providing software upgrade data to a receiver in a satellite broadcast system comprising the steps of:
notifying the broadcast receiver when a software upgrade is available;
determining the urgency of said software upgrade for said broadcast receiver;
scheduling a software upgrade session for the broadcast receiver, said software session comprising one or more software upgrade data transmissions; and
periodically transmitting data packets containing software upgrade data for said scheduled software upgrade session, to said broadcast receiver.

12. The program of claim 11 wherein said step of notifying the broadcast receiver when said software upgrade is available is comprised of an upgrade announcement message, transmitted in said data packets.

13. The program of claim 12 wherein the step of scheduling said software upgrade session comprises the steps of:
storing one or more private identification parameters within a memory storage device located in each said broadcast receiver, said private identification parameters provided by the IRD's manufacturer;
transmitting, within said data packets, public identification parameters, said public identification parameters provided by a satellite television broadcast provider; and
determining if said transmitted public identification parameters are equal to said stored private identification parameters, and if not equal, canceling said software upgrade session.

14. The program of claim 12 further comprising the steps of determining if said software upgrade session is comprised of more than one said transmission, and if so, sequentially storing, in a memory storage medium, subsequently transmitted software upgrade data corresponding to the scheduled software upgrade session.
